(19) United States
(12) Patent Application Publication
(10) Pub. No.: US 2023/0269838 A1
(43) Pub. Date: Aug. 24, 2023

(54) HYBRID EASY TO CLEAN COATING FOR MICROWAVE APPLIANCE

(71) Applicant: Whirlpool Corporation, Benton Harbor, MI (US)

(72) Inventors: Hua GUO, Guangdong Province (CN); Muhammad KHIZAR, St. Joseph, MI (US)

(73) Assignee: Whirlpool Corporation, Benton Harbor, MI (US)

(21) Appl. No.: 18/169,533

(22) Filed: Feb. 15, 2023

Related U.S. Application Data
(60) Provisional application No. 63/313,492, filed on Feb. 24, 2022.

(51) Int. Cl. H05B 6/64; H05B 6/68

(52) U.S. Cl. CPC H05B 6/6402; H05B 6/6408; H05B 6/687

(57) ABSTRACT

A heating appliance includes a housing having interior walls with interior surfaces defining a cooking chamber for heating food, a microwave heating source configured to generate microwave radiation for heating the food, and a hybrid easy-to-clean coating on at least a portion of the interior surfaces, the hybrid easy-to-clean coating including a microwave absorbing component and a super hydrophobic component.

### CROSS-REFERENCE TO RELATED APPLICATIONS

This application claims the benefit of U.S. provisional application Ser. No. 63/313,492 filed Feb. 24, 2022, the disclosure of which is hereby incorporated in its entirety by reference herein.

### TECHNICAL FIELD

The present application is directed to a cooking appliance, and more particularly an easy to clean coating for heating appliances which use microwave heating.

### BACKGROUND

Ovens are heating appliances for food preparation having a housing defining a cavity forming a cooking chamber therein. Ovens include a heating mechanism for cooking food placed within the cooking chamber, with the heating mechanism being variable across different types of ovens, and two or more types of heating mechanisms may be combined in combination ovens. Common types of ovens include electric ovens (which include conduction/conventional and convection ovens), gas ovens, toaster ovens, and microwave ovens. The heating mechanisms vary across these ovens, with some including the heating mechanisms within the cooking chamber itself (e.g., conventional ovens), or in the housing (e.g., convection ovens) such that energy or heat is transferred to the cooking chamber or the food. The heating mechanism in electric ovens includes electric coils (with circulation via fans in convection ovens) to heat the cooking chamber, in gas ovens includes burning natural gas to heat the cooking chamber, and in microwave ovens includes electromagnetic radiation via strong radio waves from devices such as magnetrons to heat the food itself.

Food placed within the cooking chamber upon heating may splatter or otherwise adhere to the interior surfaces of the chamber. As such, surfaces that are easy to clean are desirable.

### SUMMARY

According to one or more embodiments, a heating appliance includes a housing having interior walls with interior surfaces defining a cooking chamber for heating food, a microwave heating source configured to generate microwave radiation for heating the food, and a hybrid easy-to-clean coating on at least a portion of the interior surfaces, the hybrid easy-to-clean coating having a water contact angle of at least 150 degrees thereon. The hybrid easy-to-clean coating includes a microwave absorbing component and a super hydrophobic component.

In one or more embodiments, the super hydrophobic component may be a polymer-aero gel composite. In further embodiments, the polymer aerogel composite may be a polysilicate aerogel. In one or more embodiments, the microwave absorbing component may include carbon nanotubes and a high temperature ferrite material. In at least one further embodiment, the carbon nanotubes are multi-walled carbon nanotubes. In at least another further embodiment, the high temperature ferrite is Ni ferrite, Mn ferrite, or combinations thereof. In at least one embodiment, the hybrid easy-to-clean coating further includes an antimicrobial component. In certain embodiments, the antimicrobial component may be metallic Zn nanoparticles, metallic GaN nanoparticles, or combinations thereof.

According to one or more embodiments, a heating appliance includes a housing having interior walls with interior surfaces defining a cooking chamber for heating food, the interior walls including a base, side walls, and a ceiling, a microwave heating source configured to generate microwave radiation for heating the food, and a hybrid easy-to-clean coating on at least a portion of one or more of the interior walls. The hybrid easy-to-clean coating includes a high temperature ferrite, carbon nanotubes, and polymer aero-gel composite, and has a water contact angle of at least 150 degrees thereon.

In at least one embodiment, the hybrid easy-to-clean coating may further include a two-system based pre-polymerized polymer binder. In one or more embodiments, the high temperature ferrite may be Ni ferrite, Mn ferrite, or combinations thereof. In at least one embodiment, the hybrid easy-to-clean coating may include antimicrobial component of metallic Zn nanoparticles, metallic GaN nanoparticles, or combinations thereof. According to one or more embodiments, the polymer aero-gel composite may be a polysilicate aerogel.

According to one or more embodiments, a hybrid easy-to-clean coating for a microwave appliance includes 5-55 wt % of a microwave absorbing two-system based pre-polymerized polymer; 0.3-15 wt % of a microwave absorbing material including a high temperature ferrite; and 20-85 wt % of a polymer aero-gel composite material.

In at least one embodiment, the coating may comprise 15-45 wt % of the microwave absorbing two-system based pre-polymerized polymer. In one or more embodiments, the coating may comprise 0.5-10 wt % of the high temperature ferrite. In at least one embodiment, the coating may comprise 30-75 wt % of the polymer aero-gel composite material. According to at least one embodiment, the coating may further comprise 0.01-20% wt of antimicrobial material, and 0.01-2 wt % of filler. In one or more embodiments, the polymer aero-gel composite material may be a polysilicate aerogel. In at least one embodiment, the microwave absorbing material further includes carbon nanotubes.

### BRIEF DESCRIPTION OF THE DRAWINGS

FIG. 1 is a schematic front view of a heating appliance, according to an embodiment;

FIGS. 2A-B show images of water drops on an aero-gel powder, according to various embodiments;

FIG. 3 is a schematic illustration of a water droplet on a coated surface, according to an embodiment; and

FIGS. 4A-D are enlarged side illustrations of water droplets on coated surfaces depicting the water contact angles, according to various embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

According to one or more embodiments, a heating appliance, such as a microwave, may include a housing having interior walls with interior surfaces defining a cooking chamber for heating food, a microwave heating source configured to generate microwave radiation for heating the food, and a hybrid easy-to-clean coating on at least a portion of the interior surfaces, the hybrid easy-to-clean coating including a microwave absorbing material and a super hydrophobic material.

During cooking in microwave ovens, food splatter is very likely, resulting in the liner walls that form the microwave inner cavity becoming dirty and messy, with food adhered thereto. Due to greasy oils used in foods, such grease may be difficult to remove and clean from liner walls. Some other ingredients, for example, such as mustard or other food soils, if not cleaned immediately, have the potential to stain or leave spotty and patchy surfaces which decreases the aesthetic appeal of the appliance. Microwave inner cavity hygiene and odor is another issue if the walls are not cleaned immediate after use.

Conventional solutions to address microwave inner cavity cleaning exist, however the cavity staining, hygiene and odor may remain an issue because the adhering of food particles and soil on the inner cavity liner walls being struck with high frequency (2.45 GHz) microwave radiation, which passes through the food particles. Conventional solutions include liners made of certain high impact polymers and steel metals, however the food particles and soil can still adhere to the cavity liner walls. Furthermore, some conventional liner walls have had hydrophobic coatings applied thereon, however due to the high relative moisture in the inner cavity, conventional coatings cannot withstand the average life span (e.g., 5 to 10 years) of a microwave oven. Another issue with conventional coatings is high frequency microwave radiation being absorbed into the coating. The absorbed radiation resulted in limited bonding and adhesion of the coating, which impacts the durability and life span of the liner.

According to one or more embodiments, a heating appliance for cooking food, such as a microwave oven or a combination oven is provided. The heating appliance includes at least a microwave heat source, and has a cooking chamber defined by cavity walls in a housing. A hybrid, easy-to-clean coating is provided on one or more cavity walls forming the cooking chamber. The hybrid easy-to-clean coating can be applied to inner surfaces of the cavity walls, and be coated on at least a portion of the inner surfaces. The hybrid easy-to-clean coating improves cleanability performance (i.e., less adhesion of particles to the inner walls), as well as scratch resistance and anti-staining properties for the cavity liner, while exhibiting a durable bond under normal microwave radiation use due to the improved microwave absorption of the coating.

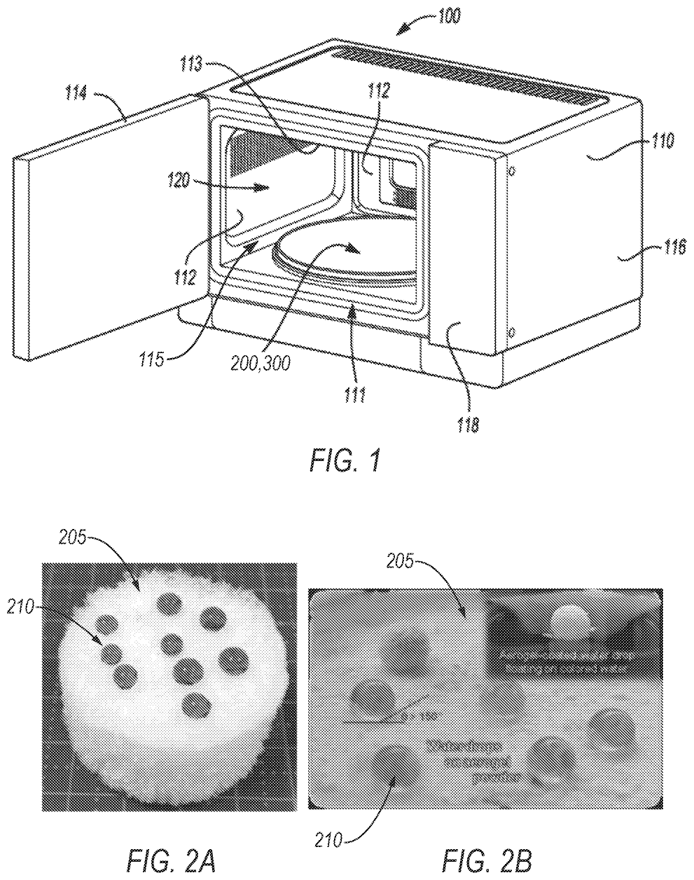

Referring to FIG. 1, a perspective view of a heating appliance 100 is shown, according to an embodiment. The heating appliance 100 is shown and described herein with reference to only the relevant general components, which is not intended to be limiting, as the heating appliance 100 includes other components and features for operation that are not shown or described herein but are expected as being included in the heating appliance 100. The heating appliance 100 includes a housing 110 with interior walls (or liners) 115, including side walls 112, a base 111, and a ceiling 113 which cooperate to define a cooking chamber 120 with a surface 300 for receiving a food item thereon for cooking. The interior walls 115 or, collectively side walls 112, base 111, and ceiling 113 may each be formed of a plastic or metal material, or combinations thereof. The housing 110 also has an outer surface 116 exposed to the external environment. The heating appliance 100 includes a door 114 having an open position for providing access to the cooking chamber 120, and a closed position sealing the cooking chamber 120 from the external environment. The cooking chamber 120 is sized based on suitable sizes for kitchen appliances and for receiving food items to be cooked, and may include components for optimizing space and cooking of the food items, such as a turntable (shown as surface 300) or shelving racks (not shown). The heating appliance 100 may draw power from an external power source (not shown) such as an electrical plug and outlet connection. The heating appliance 100 may be connected to the power supply via any suitable power cable, and may include any other components such as, but not limited to, power inverters, transformers, voltage converters, etc., to supply the requisite power to features of the heating appliance 100. The input may be any suitable input based on the appliance 100. For example, the voltage input may be 120 V and the maximum power may be 1600 W.

The heating appliance 100 includes at least one heating mechanism (not shown) for cooking food placed within the cooking chamber 120. The heating mechanism is activated by user input at a control panel 118 located on the outer surface 116 (as shown in FIG. 1) or the door 114 (not shown). The heating mechanism may be included within the housing 110 or within the cooking chamber 120, as dependent on the particular type of heating appliance 100. The heating mechanism may be a microwave heat source for heating food via microwave radiation from a suitable microwave generating mechanism, such as, but not limited to, or one or more magnetrons or solid-state devices. Although the heating appliance 100 may be referred to as microwave oven 100, and a microwave oven is depicted in FIG. 1, this is not intended to be limiting and other types of heating appliances such as combination ovens that include a microwave generating mechanism for microwave heating along with another heating mechanism (e.g., electric coils and/or gas) are also contemplated as the heating appliance 100. As such, the heating appliance 100 may be any suitable domestic appliance for cooking food, such as, but not limited to, ovens, microwave ovens, toaster ovens, and the like, such that the features described herein for the heating appliance 100 are suitable for oven or microwave oven applications where microwaves are present within the cooking chamber 120. In the embodiment shown in FIG. 1, the heating appliance 100 is a microwave such that the heating mechanism may be a microwave generating device (not shown), which is disposed in the housing 110 in any suitable manner, e.g., between the side walls 112, the ceiling 113, or the base 111, and the outer surface 116. The microwave radiation is generated by the microwave generating device and transmitted via any suitable mechanism, such as a waveguide, a coaxial cable or a strip line which supplies the microwave radiation to one or multiple feeding ports (as dependent on the design of the heating appliance 100) which are open to the cooking chamber 120 to heat food placed therein.

According to various embodiments, the heating appliance 100 (or, hereinafter, interchangeable, microwave appliance 100) includes a hybrid easy-to-clean coating 200 on at least a portion of one or more corresponding inner surfaces forming the cooking chamber 120, such as the base 111 (as shown schematically on surface 300 in FIG. 1), or on the interior walls 115, such as the side walls 112 or the ceiling 113, or combinations thereof, hereinafter collectively referred to as side walls 112. The hybrid easy-to-clean coating 200 offers improved bonding and adhesion to the interior walls 115 while providing a surface with improved cleanability (i.e., food particles are less strongly bonded to the hybrid easy-to-clean surface than to an uncoated or conventionally coated surface), while also exhibiting improved microwave absorbance without compromising the durability and bonding of the coating 200 to the interior walls 115 over the life time of the heating appliance 100. Moreover, the hybrid easy-to-clean coating 200 may be incorporated on at least a portion of one or more of the interior walls 115 (e.g., at least a portion of one or more of side walls 112, ceiling 113, or the base 111). In certain embodiments, the interior walls 115 may be metal walls, and in other embodiments, the interior walls 115 may be plastic walls. The various embodiments will be referred to collectively with like reference numerals hereinafter.

In at least one embodiment, the hybrid easy-to-clean coating 200, to be applied to at least portions of one or more of the interior walls 115, comprises a microwave absorbing material binder, a microwave absorbing material, and a super hydrophobic easy-to-clean material. The hybrid easy-to-clean coating 200 may also include an antimicrobial material, auxiliary ingredients, and/or fillers. The auxiliary and/or fillers may be, for example, volume fillers, corrosion inhibitors, particles that provide shielding action against oxidation at high temperatures (i.e., up to 500 degrees C.), thickeners, dispersants for aiding in deposition or film formation, and the like, and combinations thereof.

The microwave absorbing material binder of the hybrid easy-to-clean coating 200 may be any suitable binder, including, for example, but not limited to, a two-system based pre-polymerized polymer. The hybrid easy-to-clean coating 200 to be applied includes, in some embodiments, 5 to 55 wt % of the microwave absorbing material binder, in other embodiments, 10 to 50 wt %, and in yet other embodiments, 15 to 45 wt %.

The hybrid easy-to-clean coating 200 includes, in at least one embodiment, 0.30 to 15 wt % of the microwave absorbing material, in other embodiments, 0.40 to 12.5 wt %, and in yet other embodiments, 0.5 to 10 wt %. The microwave absorbing material may be any suitable microwave absorbing material, including, for example, but not limited to, a high temperature ferrite (i.e., a maximum temperature rating for the ferrite is at least 500 degrees C. in certain embodiments, and in some other embodiments 350 to 500 degrees C.) mixed with carbon nanotubes. In further examples, the carbon nanotubes may be multi-walled carbon nanotubes. In yet further examples, the high temperature ferrite may be Ni ferrite and/or Mn ferrite. The carbon nanotubes may be loaded in any suitable concentration to form the microwave absorbing material for the hybrid easy-to-clean coating 200. For example, the carbon nanotubes may have a loading concentration in the coating of 0.001 to 30% by weight, in other embodiments 0.01 to 10% by weight, and in yet further embodiments, 0.10 to 5.0% by weight, as based on the wet loading in the coating for deposition. With regard to microwave radiation absorption, the hybrid easy-to-clean coating 200 in some embodiments has an absorptivity to microwaves of 70 to 100%, in other embodiments, 75 to 97.5%, and in yet other embodiments, 80 to 95%. The absorptivity of the coating 200 is based on the measure of a materials' effectiveness in absorbing radiant energy at the 2.45 GHz radiation frequency used for microwave appliances.

Also, the hybrid easy-to-clean coating 200 includes 20 to 85 wt % of the super hydrophobic easy-to-clean material in some embodiments, 25 to 80 wt % of super hydrophobic easy-to-clean material in other embodiments, and 30 to 75 wt % of super hydrophobic easy-to-clean material in yet other embodiments. The super hydrophobic easy-to-clean material may be any suitable material, including, for example, but not limited to, a polymer-aerogel composite having a water contact angle of at least about 150°, in some embodiments, and at least 155° in further embodiments, and 155 to 162° in yet further embodiments, and a contact angle hysteresis of less than about 1°. In embodiments where the super hydrophobic easy-to-clean material is a polymer-aerogel composite, the coating formulation form of the polymer-aerogel composite includes a polymer and an ultra high water content catalyzed aerogel, such as, for example, polysilicate aerogel. The polymer-aerogel composite may include a three dimensional network of particles having surface functional groups derivatized with a suitable deriving agent and a plurality of pores. In an example, the particles may be silica particles and the deriving agent may be a silylating agent.

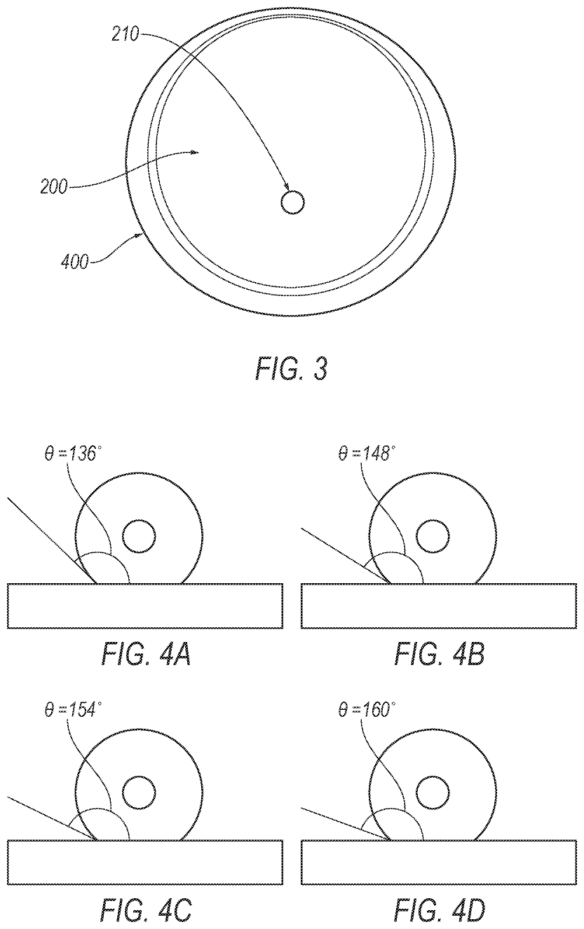

As shown in FIGS. 2A-B, images of water droplets on an example super hydrophobic component used in the coating 200 are shown, with droplets 210 formed on the super hydrophobic easy-to-clean material 205 such that the droplets 210 have a water contact angle of at least 150°, with the super hydrophobic easy-to-clean material component shown as a polymer aero-gel composite. Furthermore, as shown in FIG. 2B, a depiction of a water droplet coated with a super-hydrophobic easy-to-clean material 205 is shown floating on dyed water, along with a close up view of the water droplets 210 on the easy-to clean material component 205. FIG. 3 shows an illustration of a water droplet 210 on a surface 400, with the hybrid easy-to-clean coating 200 disposed thereon, according to an embodiment. Thus, the contact angle of the water droplet 210 on a coating 200, as shown in FIGS. 4A-D, is at least 130 degrees in some embodiments, at least 140 degrees in further embodiments, and at least 150 degrees in yet further embodiments.

The hybrid easy-to-clean coating 200 also optionally includes an antimicrobial material. The antimicrobial material may be any suitable active ingredient for hygiene, such as, but not limited to, metallic Zn and GaN. In one or more examples, the metallic Zn and GaN are provided as nanoparticles. In embodiments with the antimicrobial material, the antimicrobial material may comprise 0.005 to 25 wt % of the hybrid easy-to-clean coating 200 in at least one embodiment, 0.0075 to 22.5 wt % in other embodiments, and 0.01 to 20 wt % in yet other embodiments. The hybrid easy-to-clean coating may include a balance of filler or auxiliary ingredients. The weight percent above may be, in some embodiments, based on the coating composition prior to application and/or curing on the interior walls 115.

In an embodiment, the hybrid easy-to-clean coating 200 has a composition of 15 to 45 wt % of microwave absorbing material binder, 0.5 to 10 wt % of microwave absorbing material, 30 to 75 wt % of super hydrophobic easy-to-clean material, 0.01 to 20% wt of antimicrobial material, and 0.01 to 2 wt % of other auxiliary ingredients.

To prepare the coating 200, all the raw materials are proportionally mixed together. For example, the coating 200 may be mixed using a 3D motorized control mixer. The coating 200 is then applied to the interior walls 115 by any suitable deposition technique, including but not limited to, rolling, printing spraying, or otherwise applying the coating. The coating 200 may then be cured to form the coated liner for the cooking chamber 120. The curing may include any suitable curing mechanisms, including, but not limited to, heat, time, UV light, drying, or other curing. For example, the coating may be cured in any suitable temperature. In at least one embodiment, the temperature may be between 20 degrees and 500 degrees C., and in other embodiments, the temperature may be between 25 and 400 degrees C. The curing may be, for example, for any suitable amount of time. In some embodiments, the time may be 1 minute to 24 hours or a number of days, and in other embodiments, 10 minutes to 24 hours, as dependent on the heat applied (i.e., in an oven/furnace vs. curing at room temperature). The coating 200 is cured such that the bonding between the coating 200 and the interior walls 115 is sufficient to last the life span (i.e., up to at least 5 years in some embodiments, and up to at least 10 years in other embodiments, while undergoing normal use).

The hybrid easy-to-clean coating 200 on the interior walls 115 may have any suitable thickness and may be deposited on at least a portion of the interior walls 115, and in some embodiments, may have a thickness of 0.25 to 10 mm, in other embodiments 0.5 to 9 mm, and in yet other embodiments 1 to 8 mm. Furthermore, the interior walls 115 may include one or more layers of the hybrid easy-to-clean coating 200 thereon. As such, any suitable number of layers of the hybrid easy-to-clean coating 200 may be deposited on the inner surfaces. The layers may deposited by any suitable method, and may be cured independently or collectively on the interior walls 115. Moreover, the hybrid easy-to-clean coating 200 may be incorporated in one or more of the interior walls 115, all the interior walls 115, or in any combination of interior walls 115. Moreover, the hybrid easy-to-clean coating 200 may be incorporated on a portion of the respective interior wall 115. For example, the hybrid easy-to-clean coating 200 may be coated on 30 to 100% of the interior wall 115, in some embodiments, 50 to 95% of the wall 115 in other embodiments, and 75 to 90% of the wall in yet other embodiments.

As such, the microwave appliance 100 includes a hybrid easy-to-clean coating 200 on the inner surface of the cavity walls 130 that define the cooking chamber 120. The hybrid easy-to-clean coating 200 reduces adhesion of food particles to the cavity walls 130 (via the water contact angle), while remaining bonded to the walls 130 in the presence of microwave radiation over the life span of the appliance 100 (via the microwave absorption capabilities).

Except where otherwise expressly indicated, all numerical quantities in this disclosure are to be understood as modified by the word “about”. The term “substantially,” “generally,” or “about” may be used herein and may modify a value or relative characteristic disclosed or claimed. In such instances, “substantially,” “generally,” or “about” may signify that the value or relative characteristic it modifies is within ±0%, 0.1%, 0.5%, 1%, 2%, 3%, 4%, 5% or 10% of the value or relative characteristic (e.g., with respect to transparency as measured by opacity). Practice within the numerical limits stated is generally preferred. Also, unless expressly stated to the contrary, the description of a group or class of materials by suitable or preferred for a given purpose in connection with the disclosure implies that mixtures of any two or more members of the group or class may be equally suitable or preferred.

As referenced in the figures, the same reference numerals may be used herein to refer to the same parameters and components or their similar modifications and alternatives. For purposes of description herein, the terms “upper,” “lower,” “right,” “left,” “rear,” “front,” “vertical,” “horizontal,” and derivatives thereof shall relate to the present disclosure as oriented in FIG. 1. However, it is to be understood that the present disclosure may assume various alternative orientations, except where expressly specified to the contrary. It is also to be understood that the specific devices and processes illustrated in the drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. The drawings referenced herein are schematic and associated views thereof are not necessarily drawn to scale.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A heating appliance, comprising:
a housing having interior walls with interior surfaces defining a cooking chamber for heating food;
a microwave heating source configured to generate microwave radiation for heating the food; and
a hybrid easy-to-clean coating on at least a portion of the interior surfaces, the hybrid easy-to-clean coating including a microwave absorbing component and a super hydrophobic component,
wherein the hybrid easy-to-clean coating has a water contact angle of at least 150 degrees thereon.

2. The heating appliance of claim 1, wherein the super hydrophobic component is a polymer-aero gel composite.

3. The heating appliance of claim 2, wherein the polymer-aero gel composite is a polysilicate aerogel.

4. The heating appliance of claim 1, wherein the microwave absorbing component includes carbon nanotubes and a high temperature ferrite material.

5. The heating appliance of claim 4, wherein the carbon nanotubes are multi-walled carbon nanotubes.

6. The heating appliance of claim 4, wherein the high temperature ferrite is Ni ferrite, Mn ferrite, or combinations thereof.

7. The heating appliance of claim 1, wherein the hybrid easy-to-clean coating further includes an antimicrobial component.

8. The heating appliance of claim 7, wherein the antimicrobial component is metallic Zn nanoparticles, metallic GaN nanoparticles, or combinations thereof.

9. A heating appliance, comprising:
a housing having interior walls with interior surfaces defining a cooking chamber for heating food, the interior walls including a base, side walls, and a ceiling;
a microwave heating source configured to generate microwave radiation for heating the food; and
a hybrid easy-to-clean coating on at least a portion of one or more of the interior walls, the hybrid easy-to-clean coating including a high temperature ferrite, carbon nanotubes, and polymer aero-gel composite,
wherein the hybrid easy-to-clean coating has a water contact angle of at least 150 degrees thereon.

10. The heating appliance of claim 9, wherein the hybrid easy-to-clean coating further includes a two-system based pre-polymerized polymer binder.

11. The heating appliance of claim 9, wherein the high temperature ferrite is Ni ferrite, Mn ferrite, or combinations thereof.

12. The heating appliance of claim 9, wherein the hybrid easy-to-clean coating includes antimicrobial component of metallic Zn nanoparticles, metallic GaN nanoparticles, or combinations thereof.

13. The heating appliance of claim 9, wherein the polymer aero-gel composite is a polysilicate aerogel.

14. A hybrid easy-to-clean coating for a microwave appliance, the coating comprising:
5-55 wt % of a microwave absorbing two-system based pre-polymerized polymer;
0.3-15 wt % of a microwave absorbing material including a high temperature ferrite; and
20-85 wt % of a polymer aero-gel composite material.

15. The coating of claim 14, wherein the coating comprises 15-45 wt % of microwave absorbing two-system based pre-polymerized polymer.

16. The coating of claim 14, wherein the coating comprises 0.5-10 wt % of high temperature ferrite.

17. The coating of claim 14, wherein the coating comprises 30-75 wt % of polymer aero-gel composite material.

18. The coating of claim 14, further comprising 0.01-20% wt of antimicrobial material, and 0.01-2 wt % of filler.

19. The coating of claim 14, wherein the polymer aero-gel composite material is a polysilicate aerogel.

20. The coating of claim 14, wherein the microwave absorbing material further includes carbon nanotubes.
